(19) United States
(12) Patent Application Publication
(10) Pub. No.: US 2015/0076009 A1
(43) Pub. Date: Mar. 19, 2015

(54) PULSED SIGNAL TESTING OF BIOLOGICAL FLUID

(71) Applicant: AccuNostics Limited, Forres (GB)

(72) Inventors: Alan McNeilage, Inverness (GB); Dominic Steele, Nairn (GB); Zhiyan Wang, Forres (GB)

(21) Appl. No.: 14/396,670

(22) PCT Filed: May 2, 2013
(86) PCT No.: PCT/GB2013/051153

§ 371 Date: Oct. 23, 2014

(30) Foreign Application Priority Data
May 4, 2012 (GB) 1207869.7

(51) Int. Cl. G01N 27/416

(52) U.S. Cl. CPC G01N 27/416
USPC 205/792; 204/403.01

(57) ABSTRACT

A method of measuring a sample that includes at least one reactant that can be oxidised and reduced between at least one working electrode and a counter electrode. The method involves: applying across the working and counter electrodes a cycle of at least three pulses, and measuring current at the working electrode during each pulse, wherein the at least three pulses comprise at least one over-potential pulse that has an amplitude equal to or greater than an oxidation or a reduction peak potential of the reactant; at least one under-potential pulse of amplitude less than the at least one over-potential pulse, and at least one other over-potential pulse or under-potential pulse.

### FIELD OF THE INVENTION

The present invention relates to a test meter for testing biological fluid using pulsed signals.

### BACKGROUND OF THE INVENTION

There is an ever expanding demand for low cost, accurate and easy to use diagnostics systems that allow patients and clinicians to measure and monitor a wide variety of analytes and physiological factors. Systems that allow the accurate, safe and cost effective measurement of analytes or physiological blood based properties relating to common health conditions are of particular interest. Examples of such analytes and blood properties include glucose, cholesterol, blood ketones, haematocrit, numerous cardiac health bio markers and blood clotting time. Whilst numerous examples of such diagnostic devices are known, the cost and accuracy of such devices remains of significant concern to patients, insurers and health care professionals alike. For many such assays, the test sample viscosity is of direct interest, as is the case for systems that measure blood clotting time.

Devices that allow patients to measure their blood clotting time are now commercially available. Such devices typically have an electronic measuring device including a readout display and a disposable single use test strip. The test strip, which usually contains assay specific reagents, is typically inserted into the measuring device and a blood test sample applied to the test strip. The measuring device and test strip interact together in such a way as to allow a blood clotting time measurement to be taken from the applied test sample. However, many such devices employ intricate micro channels and complex active reagents within their test strips and/or delicate moving parts in both the test strip and the measuring device in order to allow the determination of the test sample's viscosity. Due to the relative complexity of these systems, the cost of both the measuring device and the disposable test strips are often high.

Blood viscosity plays an important role in the pathophysiology of vascular disease. A high blood viscosity increases thromboembolic risk and is correlated with the presence of systemic inflammation. Most important contributors to an increased viscosity are haematocrit, higher level of inflammatory proteins (plasma viscosity) and the loss of red cell flexibility. Applying rational strategies focusing on the characterisation and modification of blood viscosity has shown to improve diagnostics and therapy in vascular disorders.

For other diagnostic devices the test sample viscosity or rate at which a species diffuses are of interest because variations in sample viscosity/diffusion may affect the accuracy of the measurement. For example, in common episodic electrochemical glucose test strip results haematocrit impacts the ability of reactive species to diffuse through the analyte thereby impacting measured response. Information as to the rate of diffusion or viscosity would allow compensation for this effect. In other diagnostic assays the rate at which a species of interest diffuses through the test sample may be indicative of the progression of important integrations between certain reagents and the test sample, such as in certain types of immunoassays. In all of the above cases the ability to simply, accurately and cost effectively measure the rate at which a species of interest diffuses through the test sample would provide an indication of viscosity/diffusion and therefore may be important.

WO 2009/075951 describes a “rapid-read gated amperometry” method for determining the concentration of an analyte in a sample. This method is based on correlating one or more signals output from the sample measured within 300 ms of the initiation of an excitation pulse with the analyte concentration of the sample.

U.S. Pat. No. 8,105,478 describes a method for measuring the concentration or change in concentration of a redox-active substance by applying a pulsed potential to the working electrode of a measuring device. A series of measuring and relaxation phases with predetermined pulse lengths are alternately produced. In this manner, a rapid relaxation of the concentration gradient is forced electrochemically, so that the measurement can be carried out on simple transducer arrays.

WO2007/013915 describes a method for determining the concentration of an analyte in a sample using Gated Amperometry pulse sequences. The pulse sequences include multiple duty cycles having the same excitation and open circuit delay times optionally terminated by a longer terminal read pulse that increases in voltage. Such pulse sequences may reduce analysis error arising from a variety of effects including the haematocrit effect and temperature change in the sample.

### SUMMARY OF THE INVENTION

According to one aspect of the present invention, there is provided a method of measuring a sample that includes a reactant that can be oxidised or reduced between one or more working electrodes and a counter/reference electrode. (where counter/reference is taken to mean that the counter and reference electrode functions may be provided by separate electrodes or combined in a single electrode). The method involves applying across the working and counter electrodes one or more cycles of at least three pulses, and measuring current at the working electrode during each pulse, wherein the at least three pulses comprise at least one over-potential pulse that has an amplitude equal to or greater than an oxidation or a reduction peak potential of the reactant; at least one under-potential pulse of amplitude less than the at least one over-potential pulse, and at least one other over-potential pulse or under-potential pulse.

The present invention relates to a versatile method of interrogating a liquid test sample in order to determine diffusion-related factor (DRF) of a redox active species in a test sample over time or to measure the progression and outcome of diagnostics assays being carried out on the sample.

Using cycles of under and over oxidation and reduction potentials extends the lifetime of a two electrode system in which reference and counter electrode are combined and the reference/counter reaction takes place in the sample by pulsing between excitation and regeneration to regenerate reference/counter redox species.

The cycle may include at least one oxidation over-potential and at least one reduction over-potential. The cycle may include at least one reduction over-potential and at least one reduction under-potential. The cycle may include at least one oxidation over-potential and at least one oxidation under-potential. The cycle may include at least one reduction over-potential, at least one reduction under-potential and at least one oxidation over-potential.

Each pulse in the cycle may have the same or different amplitude.

The cycle may comprise in sequence an under-potential, an over-potential, and an over-potential. The cycle may comprise in sequence an under-potential, an under-potential, and an over-potential. The cycle may comprise in sequence an under-potential, an over-potential, and an under-potential.

The cycle may have at least four pulses. The cycle may comprise in sequence an under-potential, an over-potential, an under-potential and an over-potential. The cycle may comprise in sequence an under-potential, an under-potential, an over-potential and an over-potential.

At least one pulse in the cycle may be of a different polarity to other pulses in the cycle.

Applying an under-potential may be done immediately before or after applying an over-potential.

Each potential pulse may have a duration of between 0.02 s and 10 s.

Where a cycle ends with an over-potential, the duration of the last over-potential may be extended, i.e. may be longer than any of the other pulses.

The under-potential pulse duration and/or the over-potential pulse duration may be determined according to a level of decay rate in the under-potential current/over-potential current.

The under-potential pulse duration may be different to the over-potential pulse duration. Alternatively, the under-potential pulse duration may be the same as the over-potential pulse duration.

The method may further involve using measured under-potential and over-potential currents to determine a diffusion-related factor. The method may further involve calculating a ratio of the under-potential current and the over-potential current; and using the ratio to determine the diffusion-related factor.

The method may involve using a current value and the ratio to derive a diffusion-related factor. Additional current values may be used with the ratio to derive a diffusion-related factor.

Determining the diffusion-related factor may involve using the rate of change in the measured under-potential and/or over-potential current.

Determining the diffusion-related factor may involve using a ratio of the rate of change in the measured under-potential and/or over-potential currents.

The method may involve using the diffusion-related factor and a temperature dependent coefficient to obtain a viscosity related factor of the sample.

The method may involve using the diffusion-related factor to determine a change in viscosity or diffusion.

The method may involve using the diffusion-related factor to determine relative diffusion in a plasma versus whole blood.

The method may involve using the diffusion-related factor as a diagnostic value/indicator of health.

The method may involve using the diffusion-related factor to determine an analyte concentration in the sample.

The method may involve using the diffusion-related factor and a correction factor in obtaining the concentration of an analyte in the sample.

The method may involve determining the diffusion-related factor using current measured within the first 0.3 seconds of the under-potential and over-potential pulses.

Preferably, the diffusion-related factor is measured using current measured after the first 0.2 seconds. By using current measured in the first 0.3 seconds, the diffusion-related factor determined is for the near electrode analyte.

The method may involve determining the diffusion-related factor using current measured after the first 0.3 seconds of the under-potential and over-potential pulses. By using current measured after the first 0.3 seconds, the diffusion-related factor determined is for the bulk analyte.

The method may involve comparing the diffusion-related factor determined using current measured in the first 0.3 seconds and the diffusion-related factor determined using current measured after the first 0.3 seconds.

The analyte of interest in the sample may be at least one metabolic marker, such as glucose and/or cholesterol.

The working electrode and the counter electrode functions may be swapped during measurement.

The potential pulses may have a square wave profile or a sinusoidal wave profile or a triangular wave profile or a ramp profile.

A reference electrode may be used. The counter and reference electrodes may be separate, or the counter and reference electrodes may be combined in a single electrode.

The under-potential pulse duration may be two or more times longer than any over-potential pulse. This allows accumulation of analyte prior to periods of over-potential.

Between pulses there may be a transition period, the transition being between 0 and 5 seconds, ideally between 0 and 0.1 seconds.

The method may involve using an integrated current measured over a time period starting 0.01 to 0.1 seconds after the start of a pulse and lasting 0.15 to 3 seconds, ideally 0.2 to 0.5 seconds. Integrated current for at least two pulses may be used to derive a diffusion-related factor.

According to another aspect of the invention, there is provided a meter that has a voltage source and a current meter adapted to perform the method of the first aspect of the invention.

### BRIEF DESCRIPTION OF THE DRAWINGS

Various aspects of the invention will now be described by way of example only, and with reference to the following drawings, of which:

FIG. 1 shows a redox reaction at an electrode (top) and mass transport by diffusion to the electrode (bottom) across a distance (x);

FIG. 2 represents current decays with and without convection;

FIG. 3 shows a schematic representation of the reduction (left) and oxidation (right) of a redox species occurring at an electrode together with their respective current decay curves;

FIG. 4 shows a schematic representation of a current output (solid line) obtained in response to an applied pulsed potential sequence (doted lines);

FIG. 5 shows a flow diagram of a method of extracting a diffusion-related factor of a redox species;

FIG. 6 shows the Ferro current response obtained over a range of Potassium Hexacyanoferrate (II) concentrations (referred to as Ferro) and measured at over-potential (circles) and under-potential (crosses);

FIG. 7 shows the potential sequence used in experiment presented in FIGS. 8-11;

FIG. 8 shows the diffusion-related factor of Ferro in a Phosphate buffered saline (PBS) solution containing increasing concentration of Hydroxyethyl Cellulose (HEC). The concentration of Ferro used in the experiments was 2 mM (circles), 5 mM (crosses) and 7 mM (squares). The R square is obtained by linear regression using model equation DRF=Ratio X+intercept;

FIG. 9 shows the diffusion-related factor (DRF) of Ferro in a PBS solution containing increasing concentration of HEC. The concentration of Ferro used in the experiments was 2 mM (circles), 5 mM (crosses) and 7 mM (squares). The R square is obtained by linear regression using model equation DRF=Ratio X+Iop(ti) Z+intercept;

FIG. 10 shows the diffusion-related factor of Ferro in a PBS solution containing increasing concentration of HEC. The concentration of Ferro used in the experiments was 2 mM (circles), 5 mM (crosses) and 7 mM (squares). The R square is obtained by linear regression using model equation DRF=Ratio X+Iup(ti) Y+intercept;

FIG. 11 shows the diffusion-related factor of Ferro in a PBS solution containing increasing concentration of HEC. The concentration of Ferro used in the experiments was 2 mM (circles), 5 mM (crosses) and 7 mM (squares). The R square is obtained by linear regression using model equation DRF=Ratio X+Iup(ti) Y+Iop(ti) Z+intercept;

FIG. 12 shows the R square values corresponding to FIGS. 7-10;

FIGS. 13-19 show examples of pulsing sequences and current output responses. The examples are based on a system in which the redox species has an oxidation potential between 300 and 400 potential units;

FIGS. 20 to 22 show other example pulse sequences;

FIG. 23 shows examples of two current signals for a three pulse cycle;

FIG. 24 shows an exploded view of a test strip for performing diffusion/viscosity measurements, and

FIG. 25 shows a schematic diagram of a test meter.

### DETAILED DESCRIPTION OF THE DRAWINGS

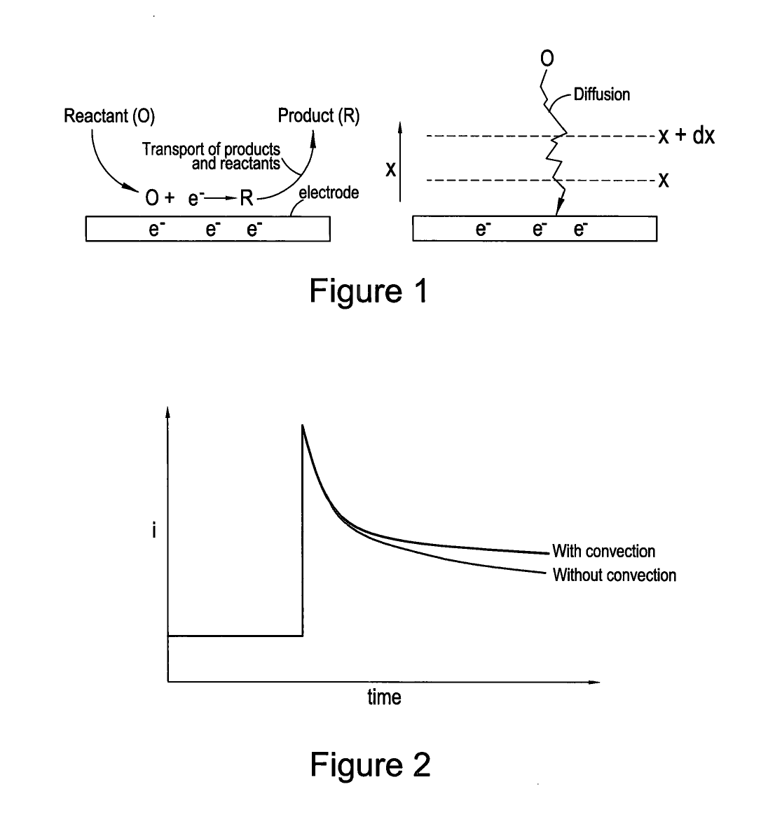

FIG. 1 illustrates the mechanism of oxidation and reduction of a redox species present in a sample and occurring at the surface of an electrode. The transport of the redox species, from the bulk solution to the surface of the electrode, can take place via three principal mechanisms, namely diffusion, migration and convection. If a concentration gradient is present in the sample, molecules move through diffusion from the area of high concentration to the area of low concentration. If an electric field is applied to the sample, charged species will migrate under the influence of the field. Finally, stirring and/or natural thermal motion in the sample triggers the transport of species via convection.

Different types of potentials can be applied to an electrode in order to drive an oxidation or a reduction reaction. The potential at which the redox reaction becomes limited by mass transport is the peak potential. When the potential applied to the electrode is greater than the absolute peak oxidation or reduction potential, the potential is described as an over-potential. An over-potential is a potential of greater than or equal amplitude than that at which the redox reaction at an electrode becomes limited by mass transport. At the over-potential the theoretical concentration of the analyte being measured is substantially zero at the electrode surface and current diffusion limited. An under-potential is a potential of lesser amplitude than that at which the redox reaction at an electrode becomes limited by mass transport. The under-potential applied to the electrode is less than the absolute peak oxidation or reduction potential (a potential at which current is not solely diffusion limited).

FIG. 2 shows a plot of the expected current output obtained from a pair of electrodes. Initially no potential is applied (flat line). Upon application of an over-potential, the current rises sharply and decays. The decay rate is initially very fast and slows down at longer time to reach a ‘steady-state’ current characterised by diffusion. The profile of the current decay can be described by the Cottrell equation where mass transport is driven by diffusion only (blue line). Where convection is present the decay is limited (black line) by the increased rate of mass transport of the redox species.

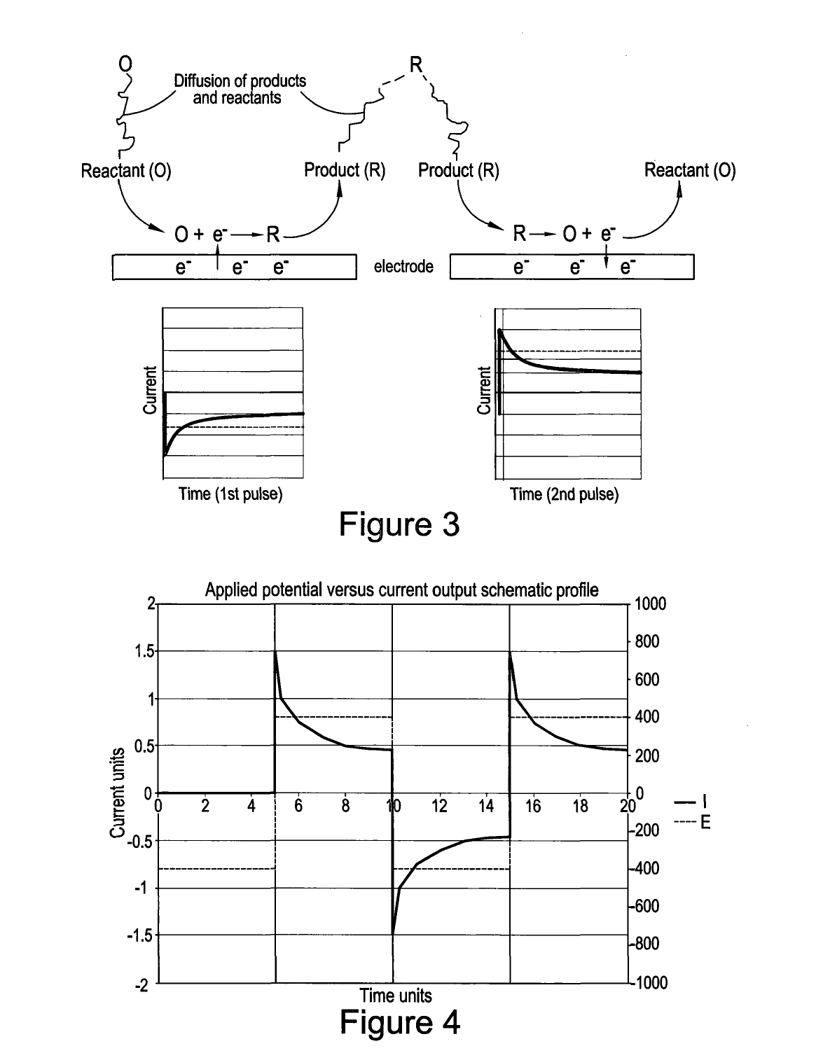

FIG. 3 shows the reduction and oxidation (both at over-potentials) of a reactant at the surface of an electrode. Successive oxidation and reduction of a redox species is used to determine the rate of mass transport of the species to the electrode. Where mass transport is dominated by diffusion it will be used to determine a diffusion-related factor (DRF) of the redox species. This does not require the concentration of the redox species to be homogenous throughout the solution and can tolerate some degree of convection.

FIG. 4 is a schematic representation of the input potential (E) versus output current (I). The potential is pulsed between over-potentials for oxidation and reduction, as illustrated by the red dotted line. The yellow shaded section represents a pre-poise period during which time a conditioning potential is applied in order to convert redox species (referred to as mediating species when used as a mediator to measure the concentration of an analyte), to a substantially uniform state (i.e. substantially oxidised or substantially reduced). In this example the pre-poise polarity could be configured to convert the mediating species to a reduced state. The red shaded areas represent regions of current dominated principally by capacitance. During the blue phases the capacitive element of the current is significantly reduced and the current decay is representative of mediating species being oxidized or reduced near the electrode. At longer time, the current is defined by mediating species diffusing to the electrode through the bulk solution. Therefore, later time points in the blue phases represent mediating species diffusing from greater distance to the electrode.

When the potentials are switched the previously generated electrochemically active oxidised (or reduced) product is then reduced (or oxidised) and a concentration gradient is created such that the species being reduced (or oxidised) will diffuse from the bulk solution towards the electrode surface. Thus, by stepping the potential any changes in the size and rate of current decay of the resultant current profiles may be indicative of a change in solution viscosity or other important factors relating to the rate of mass transport of the species of interest to the measuring electrode. The relative magnitude of the current and particularly the rate of current decay may be indicative of the rate at which the species being electrochemically oxidised (or reduced) can diffuse through the test sample. This in turn is at least partially a function of the solution diffusion coefficient, as defined by the Cottrell equation which describes the change in electric current with respect to time in a controlled potential experiment. An integrated current provides a current-time characteristic, representing a measure with components of current magnitude and rate of decay. Integrated current measures from different time periods of the current response transient can be used in the determination of a diffusion-related factor. Ideally, the current should be integrated for an under potential pulse and an over potential pulse over a time period starting 0.01 to 0.1 seconds after the start of each pulse and for a period of 0.15 to 3 seconds, ideally 0.2 to 0.5 seconds to give an integrated current for each of the under-potential pulse and the over-potential pulse.

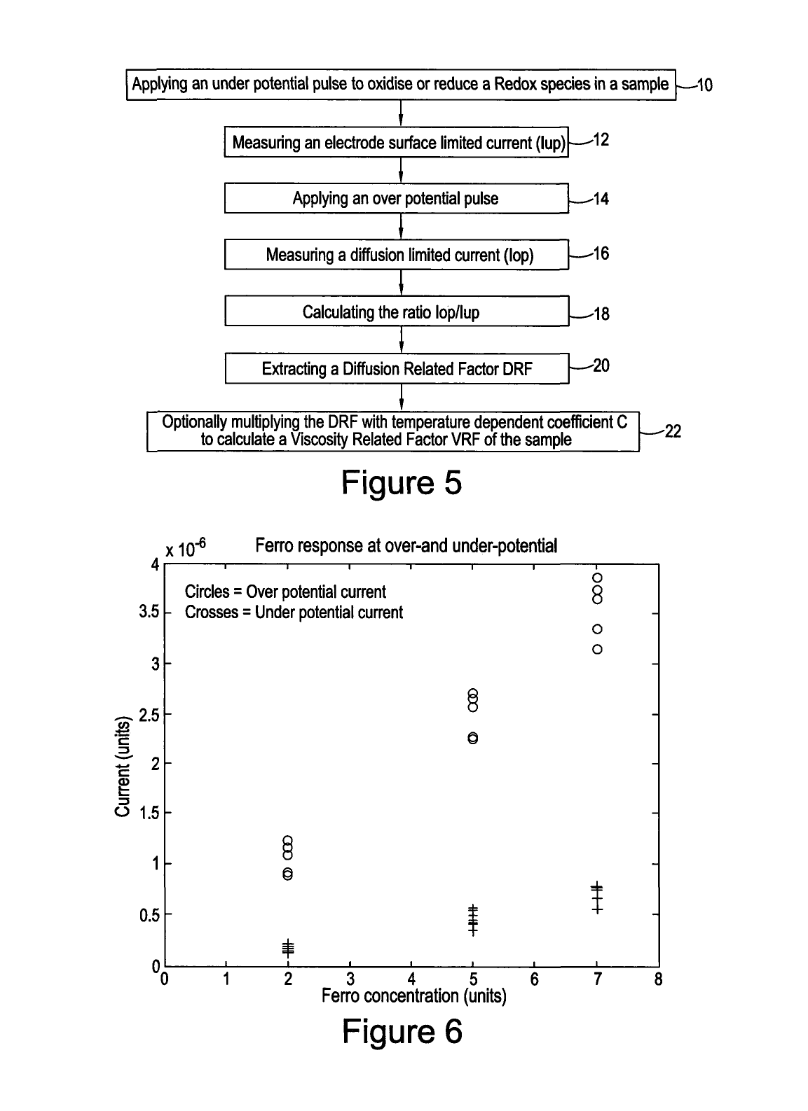

FIG. 5 shows a method for determining a diffusion-related factor DRF of a redox species in a sample. The method involves applying an under-potential pulse and an over-potential pulse to a pair of electrodes during either an excitation period (oxidation of a redox species) or a reduction period (reduction of a redox species). Current measurements are made during both the excitation and the reduction period. The steps of the method include: applying an under-potential pulse to a pair of electrodes 10, measuring an electrode surface limited current Iup 12, applying an over-potential pulse 16 having a larger amplitude than the preliminary pulse 16, measuring a diffusion limited current Iop 18, calculating the ratio Iop/Iup 20 and extracting a DRF 22.

Having potential steps between over-potentials for oxidation and reduction has several benefits over the single step illustrated in by the blue line in FIG. 2. Repeat pulsing between conditions in which the redox species is reduced and oxidized maintains concentration of the measured species at the electrode (through regeneration). This means the signal magnitude (current output) can be sustained over time. When analysing complex fluids (such as blood or other biological analytes) where events such as coagulation and sedimentation occur, this permits the study of these over time.

Having an under-potential pulse 10 preceding an over-potential pulse 16 reduces the capacitive element during the early time points of the over-potential current response allowing for an earlier current measurement to be performed.

FIG. 6 shows the current measured at an electrode at an over-potential and at a under-potential across a range of Potassium Hexacyanoferrate (II) concentrations (referred to as Ferro). When an over-potential (potential greater than the oxidation potential of the redox species) is applied to the electrode, the measured current increases linearly with the increased analyte concentration. At this potential, oxidation of the redox species occurs faster than the redox species arriving at the electrode. The current is limited by the diffusion rate of the redox species in the sample towards the electrode and is said to be “diffusion limited”. When an under-potential is applied to the electrode, the current is not solely limited by diffusion.

A diffusion-related factor (DRF) of the redox species in a sample can be derived from the ratio of current at over-potential i_{OP} to current at under-potential i_{UP} as follows:

$$DRF = {k ( \frac{{i}_{UP}}{{i}_{OP}} )}^{x}$$

where k is a predetermined scaling factor and x is a term defining a degree of linearity

The current at over-potential i_{OP} is described by the Cottrell equation which describes the change in electric current with respect to time in a controlled potential experiment, such as chronoamperometry. For a simple redox event the current measured depends on the rate at which the analyte diffuses to the electrode:

$${i}_{OP} = \frac{{nFAC}_{j}^{O} \sqrt{{D}_{j}}}{\sqrt{π t}}$$

Where i=current, in unit A, n=number of electrons (to reduce/oxidize one molecule of analyte j); F=Faraday constant, 96,485 C/mol; A=area of the (planar) electrode in cm²; cⱼ^{O}=initial concentration of the reducible analyte j in mol/cm³; Dⱼ=diffusion coefficient for species j in cm²/s; t=time in s.

The current at under-potential i_{UP} is not solely limited by diffusion and is therefore theoretically calculated using an adjusted Cottrell equation:

$${i}_{UP} = \frac{{nFAC}_{j}^{O}}{\sqrt{π t}}$$

The above equations can be adapted to give a measure of the diffusion related factor using integrated current for the under-potential and over-potential pulses.

Experimental Data

Solutions of Potassium Hexacyanoferrate (II) (Ferro) with concentrations of 2, 5 and 7 millimolar were prepared and modified with hydroxy ethyl cellulose (hereafter referred to as ‘HEC’) to give 1, 2, 3 and 4% (weight/volume) solutions. All solutions were made up in Phosphate Buffered Saline (hereafter ‘PBS’). The viscosities of the Ferro solutions are increased through the addition of HEC; the higher the percentage of HEC, the higher the viscosity of the solution and hence a reduction in the diffusion coefficient of the Ferro ion. In effect the mobility of the Ferro ion is reduced at higher viscosities.

The response was studied using a potentiostat, to measure the current response at fixed potentials. The electrochemical cell comprised a Silver/Silver Chloride reference electrode, a Platinum counter electrode and a screen-printed carbon working electrode.

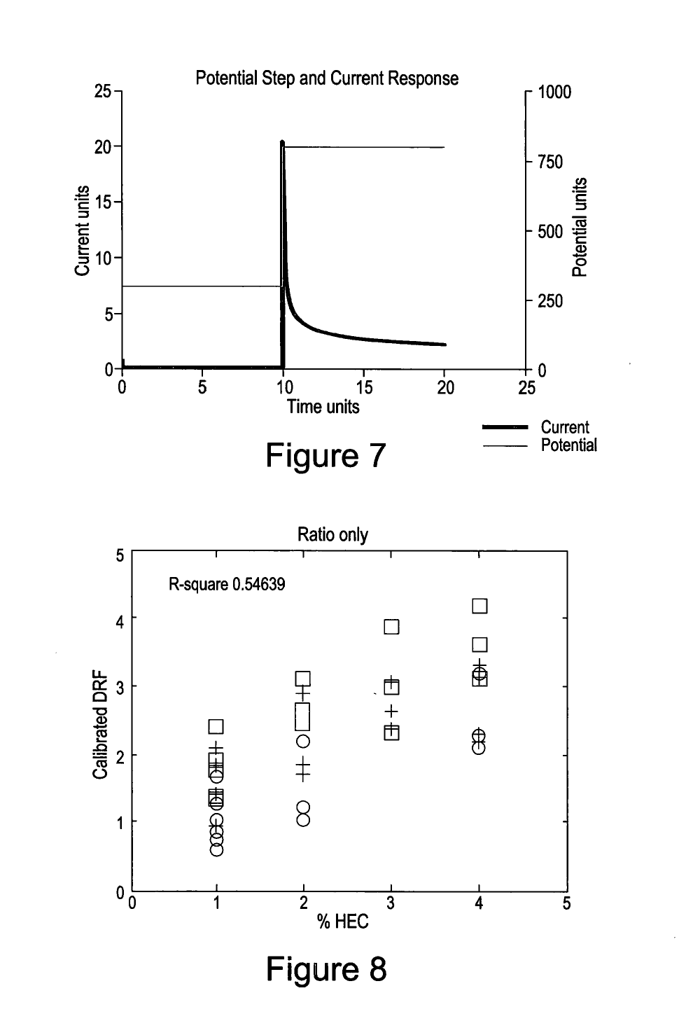

FIG. 7 shows an example of a current response to the two potential steps, the initial under-potential step (a lower potential) and the subsequent over-potential step. These may be performed in either order.

FIGS. 8 to 11 show the calculated diffusion-related factor of Ferro in a PBS solution containing increasing concentration of HEC. The concentration of Ferro used in the experiments were 2 mM (circles), 5 mM (crosses) and 7 mM (squares). Four linear models were fitted to show how diffusion-related factors (hereafter DRF) maybe calculated from the current response to account for the reduction in ferro ion mobility.

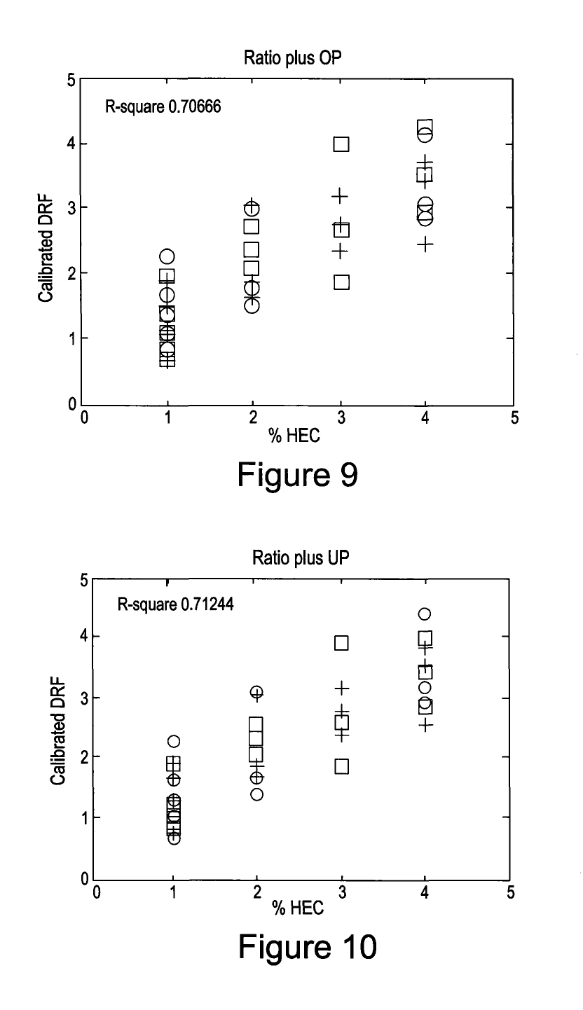

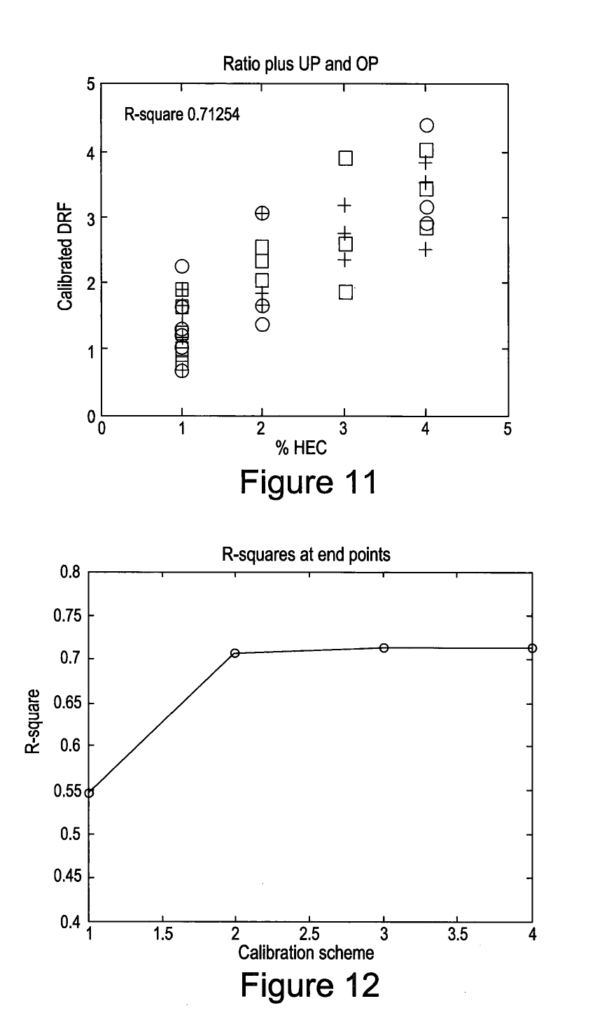

In FIG. 8, the R square is obtained by linear regression using model equation DRF=Ratio X+intercept, where “X” and “intercept” are fitting parameters. In this case, the R-square value is 0.54639. In FIG. 9, the R square is obtained by linear regression using model equation DRF=Ratio X+Iop(ti) Z+intercept, where Iop(ti) is a current value measured during the over-potential pulse at a time ti, and Z is a fitting parameter. In this case the R-square value is 0.72815. In FIG. 10, the R square is obtained by linear regression using model equation DRF=Ratio X+Iup(ti) Y+intercept, where Iup(ti) is a current value measured during the under-potential pulse at a time ti, and Y is a fitting parameter. In this case, the R-square value is 0.73191. In FIG. 11, the R square is obtained by linear regression using model equation DRF=Ratio X+Iup(ti) Y+Iop(ti) Z+intercept. In this case the R-square value is 0.73198. FIG. 12 shows the predictive capability (as measured by the R-squared value) is improved using the ratio plus an independent current point.

Pulse Sequences

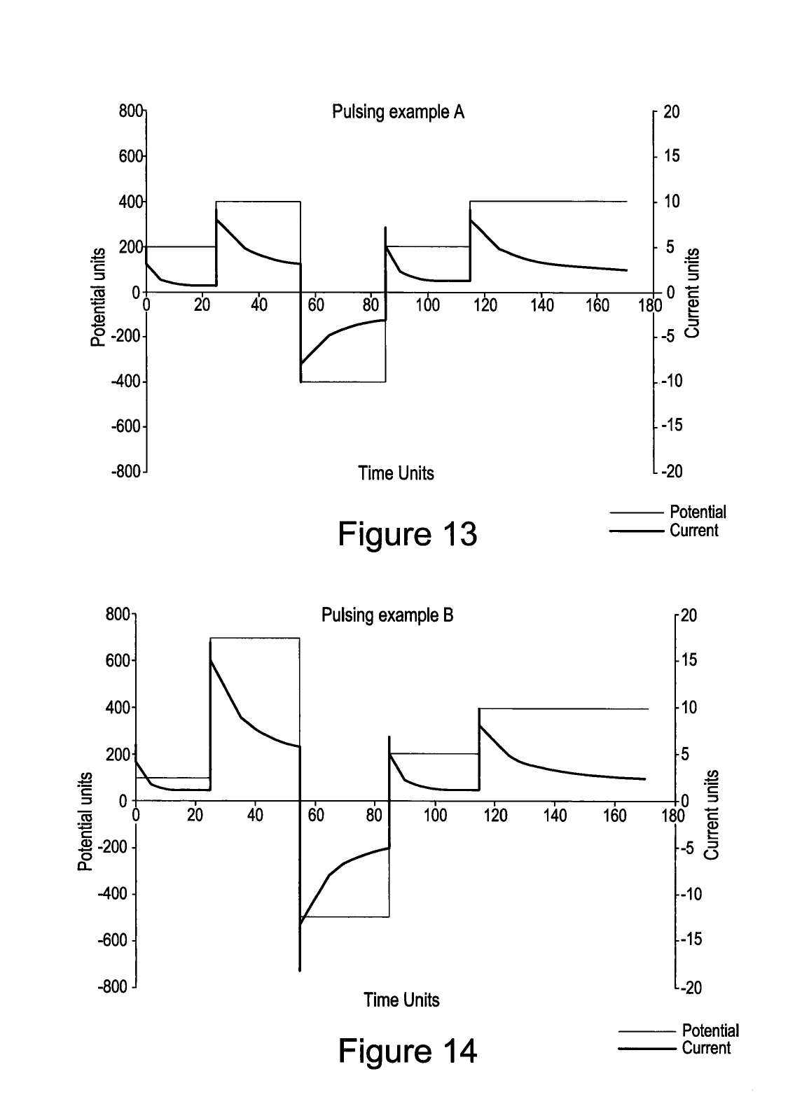

FIGS. 13 to 19 illustrate a number of possible pulse sequences for applying between a working electrode and a counter/reference electrode, and the corresponding current responses. As is known in the art, where both a counter and reference electrodes are provided, the counter and reference electrode functions may be provided by separate electrodes or combined in a single electrode by shorting on one of the electrodes.

In each of the pulse sequences shown, the under-potential excitation precedes the over-potential excitation. The under-potential reduces the magnitude of the capacitive element in the over-potential measurement.

FIG. 13 shows an example of a five pulse sequence: The first pulse is an oxidation under-potential, the second pulse is an oxidation over-potential, the third pulse is a reduction over-potential, the fourth pulse is an oxidation under-potential and the fifth pulse is an oxidation over-potential. The first and fourth pulses (at 200 potential units) produce a current not solely limited by diffusion. The second and fifth pulses have a potential amplitude greater than the oxidation potential of the redox species (over-potential), in this case 400 potential units. At this potential oxidation of the redox species occurs faster than the redox species arrives at the electrode, thus the response is limited by diffusion. This fifth pulse is of greater duration than the earlier over-potential pulse (pulse 2). The greater duration of the fifth pulse allows current measurement to be performed closer to the steady state current at which capacitive background and rate of change in current is at a minimum, leading to a high signal to noise ratio measurement. The third pulse (at −400 potential units) is a reduction potential in which the redox species is reduced at the electrode. At this potential reduced redox species is regenerated at the working electrode and oxidized redox species regenerated at the counter/reference electrode. The repetition of under-potential pulses (pulses one and four) provides a repeat measure of electrode efficiency which can be averaged along with other under-potential measurement. Alternatively the repeat measures can be analysed to determine change in efficiency between the time points. Having an under-potential pulse (pulses one and four) preceding each over-potential measurement (pulses two and five) reduces the capacitive element during the early time points of the over-potential current response allowing for an earlier measurement to be performed with reduced capacitive background.

FIG. 14 shows another five pulse sequence. The first pulse is an oxidation under-potential, the second pulse is an oxidation over-potential, the third pulse is a reduction over-potential, the fourth pulse is an oxidation under-potential and the fifth pulse is an oxidation over-potential. The two under-potentials (first and fourth pulses) have different amplitudes, for example the first pulse has a lower amplitude than the second pulse, in this case 100 potential units and 400 potential units respectively. The two over-potential pulses (second and fifth pulses) have different amplitudes for example the second pulse has a higher amplitude than the fifth pulse, in this case 700 potential units and 400 potential units respectively. The fifth pulse has also a longer duration than the second pulse, for example greater than 50 time units, allowing current measurement to be performed closer to the steady state current. The third pulse (at −500 potential units) is a reduction potential in which the redox species is reduced at the electrode. At this potential, the reduced redox species is regenerated at the working electrode and oxidized redox species regenerated at the reference (or counter) electrode.

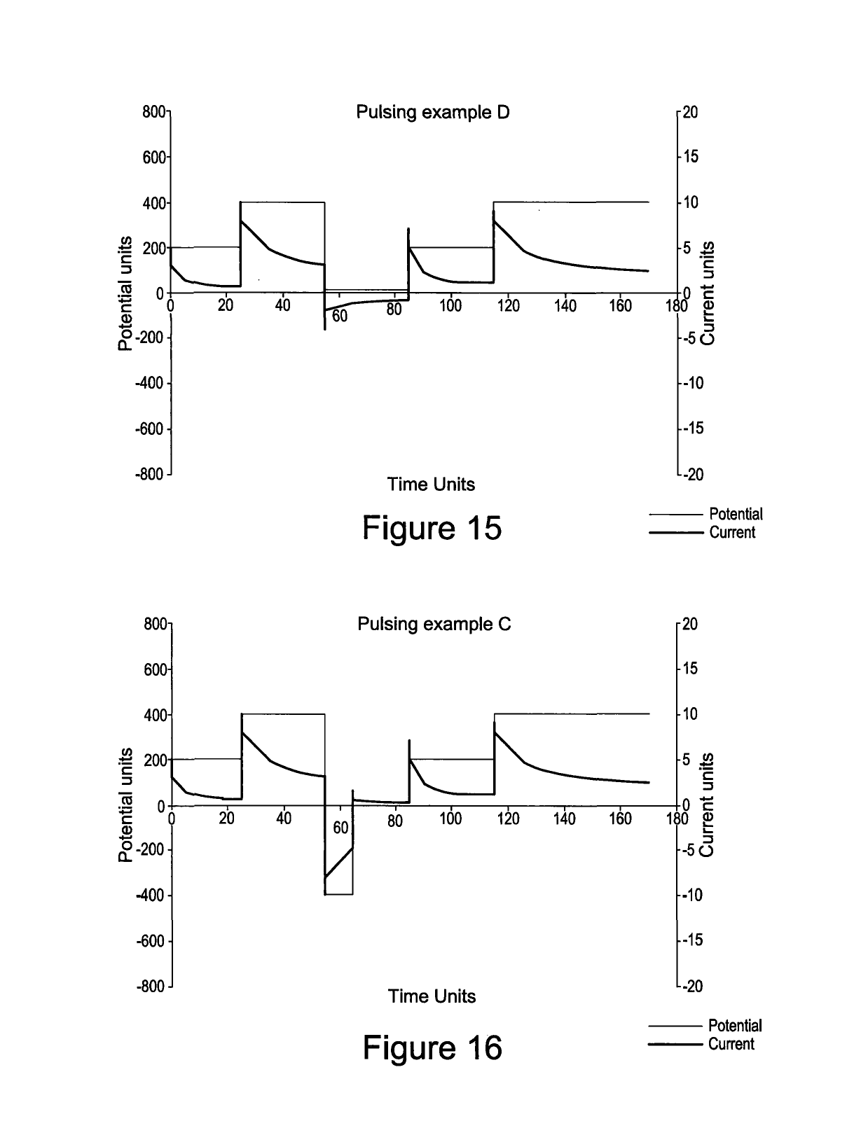

FIG. 15 shows another five pulse sequence. The first pulse is an oxidation under-potential, the second pulse is an oxidation over-potential, the third pulse is a reduction under-potential, the fourth pulse is an oxidation under-potential and the fifth pulse is an oxidation over-potential. The two under-potentials (first and fourth pulses) have the same amplitudes in this case 200 potential units. The two over-potentials (second and fifth pulses) have the same amplitudes, in this case 400 potential units. The fifth pulse has also a longer duration than the second pulse, for example greater than 50 time units, allowing current measurement to be performed closer to the steady state current. The third pulse (reduction potential) has a positive amplitude, for example in this case 10 potential units. This illustrates that the potential of the reduction potential does not need to be stepped to a negative amplitude in order for reduction to occur.

FIG. 16 shows another pulse sequence. The first pulse is an oxidation under-potential, the second pulse is an oxidation over-potential, the third pulse is a reduction over-potential, the fourth pulse is an oxidation under-potential, the fifth pulse is an oxidation under-potential and the sixth pulse is an oxidation over-potential. In this case the reduction pulse (third pulse) has a duration shorter than the other pulses, for example in this case less than 10 time units and an amplitude of −400 potential units. The following pulses (pulses four, five and six) have increasing amplitudes, for example in this case 0, 200 and 400 potential units.

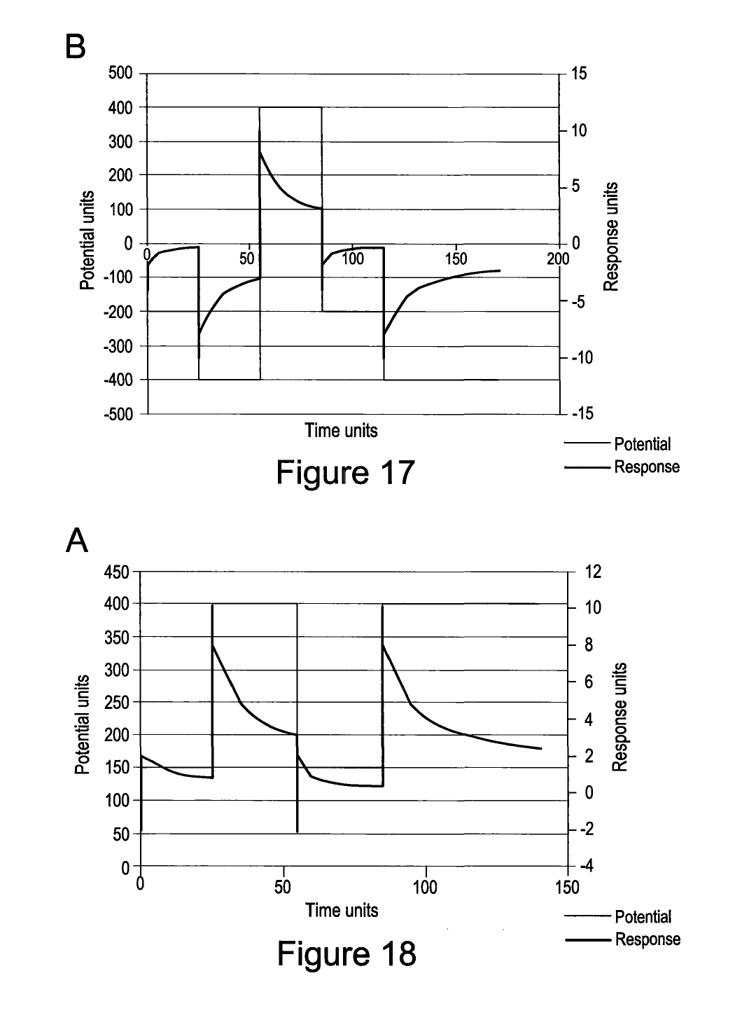

FIG. 17 shows another five pulse sequence. This is the same sequence as shown in FIG. 13, but in this case the polarity of the pulse sequence is inverted. The first pulse is a reduction under-potential, the second pulse is a reduction over-potential, the third pulse is an oxidation over-potential, the fourth pulse is a reduction under-potential and the fifth pulse is a reduction over-potential.

FIG. 18 shows another pulse sequence. In this sequence, there is no reduction potential. The first pulse is an oxidation under-potential, the second pulse is an oxidation over-potential, the third pulse is an oxidation under-potential and the fourth pulse is an oxidation over-potential. The two under-potentials (pulses one and three) have the same amplitude, in this case 150 potential units. The two over-potentials (pulses two and four) have the same amplitude, in this case 400 potential units. The fourth pulse has also a longer duration than the second pulse, for example greater than 50 time units, allowing current measurement to be performed closer to the steady state current

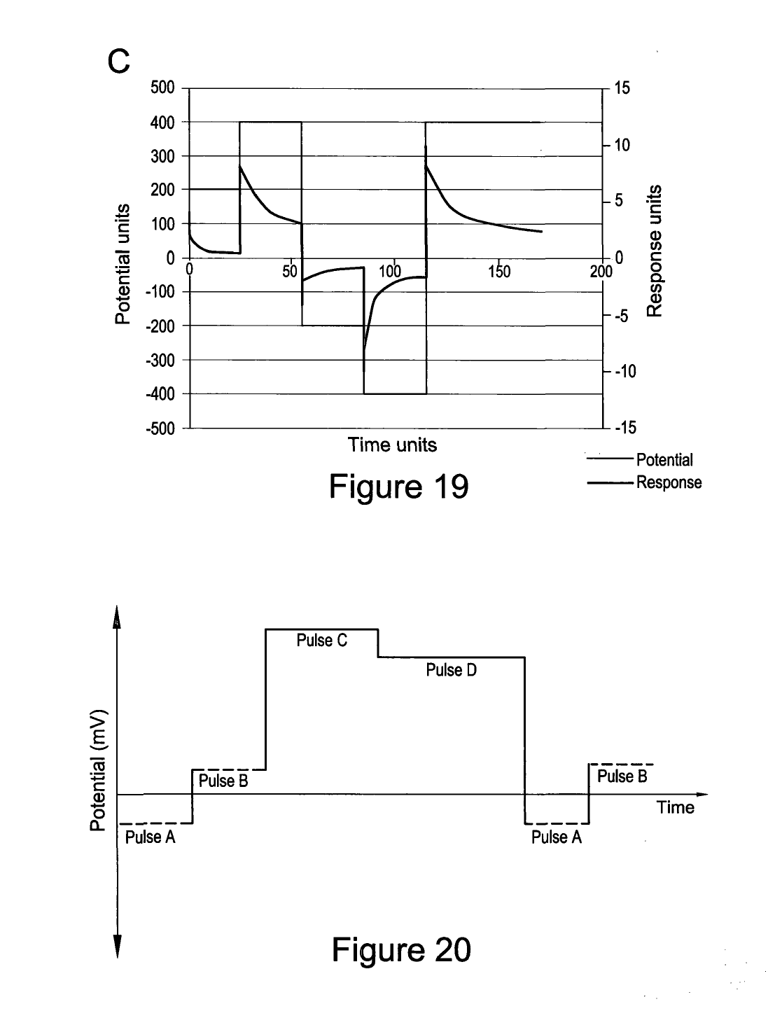

FIG. 19 shows another pulse sequence variation. The first pulse is an oxidation under-potential, the second pulse is an oxidation over-potential, the third pulse is a reduction under-potential, the fourth pulse is a reduction over-potential and the fifth pulse is an oxidation over-potential. In this case the first two oxidation potential (pulse one and two) mirror the following two reduction potentials (pulses three and four), in this case pulses one and two have an amplitude of 200 and 400 units respectively and pulses three and four have an amplitude of −200 and −400 units respectively. The fifth pulse has an amplitude of 400 units and a longer duration than the second pulse, for example greater than 50 time units, allowing current measurement to be performed closer to the steady state current.

The potential applied to the working electrode may ideally be modulated such that the potential is applied at a period of between 0.02 s and 10 s. In this context, the period is defined as the period of application of any pulse in a pulse sequence, whether an under-potential or over-potential pulse. The pulses need not be symmetric.

Further examples of pulse sequences are shown in FIGS. 20 to 22. FIG. 20 shows a four pulse sequence that is suitable for continuous monitoring of a sample. Here, the first two pulses, A and B, are under-potentials that are applied immediately before two oxidation over-potentials, pulses C and D. Pulse A is of opposite polarity to pulse B and regenerates the reference electrode reaction. Pulse B stimulates minimal positive current. Pulses C and D are oxidation over-potentials, which stimulate current flow.

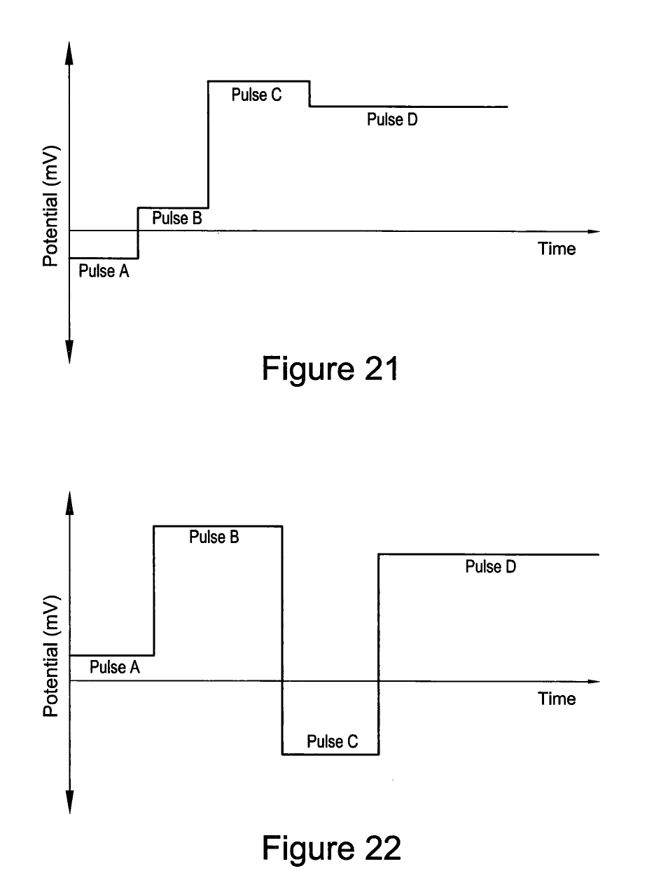

FIG. 21 shows another four pulse sequence that has two under-potential pulses, A and B, that are under-potentials applied immediately before two oxidation over-potentials, pulses C and D. Pulse A regenerates the reference electrode reaction and pulse B stimulates minimal positive current. Pulses C and D are oxidation over-potentials, which stimulate current flow. In this case, pulse D is prolonged, allowing the measured current to drop closer to a steady state.

FIG. 22 shows a sequence for that has a positive under-potential pulse A, a positive oxidation over-potential pulse B, a negative under-potential pulse C and a positive prolonged oxidation over-potential pulse D.

In all of the examples given, the under-potential pulse duration and/or the over-potential pulse duration may be determined according to a level of decay rate in the under-potential current/over-potential current. Ideally, the pulse duration should be longer than the time taken for the current to reach a steady state. A steady state is advantageous as this is a more stable condition in which to measure.

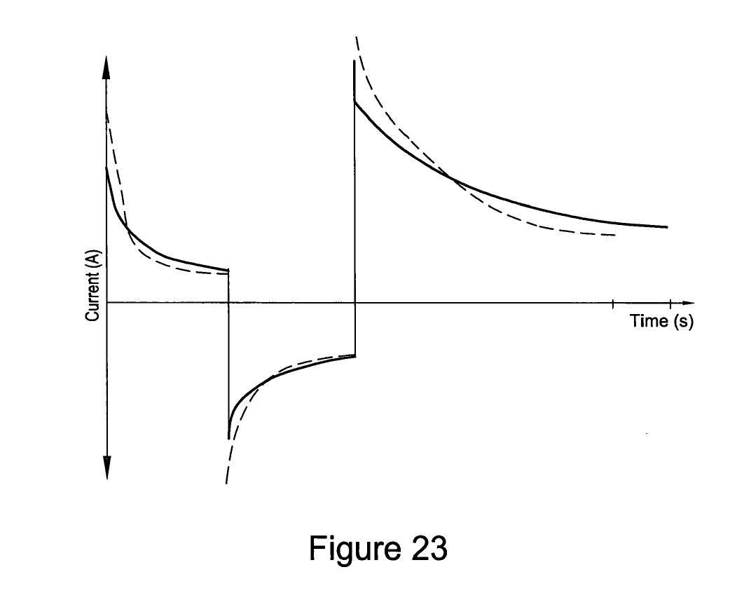

FIG. 23 shows a schematic of two current time transients generated in response to three potential pulses. Current 1 is represented by a solid line and Current 2 is represented by a broken line. From FIG. 23, it can be seen current 1 decays slower than current 2 in each of the three pulses. Current 2 reaches a steadier state faster than current 1. In order to select the optimum measurement point, the slope of a decay on any of the transients is used to determine the duration of the measurement. For example, current 2 has been observed to decay faster than current 1 and so a measure can be derived at an earlier time. The rate of decay linked to total test time might be linked to a decay slope during any of the pulses, time taken to drop by a percentage or triggered by a slope threshold. In FIG. 23, the duration of the final pulse is determined by the rate of decay determined for the preceding pulses.

In order to determine the appropriate pulse duration, the rate of current decay may be monitored and the pulse duration varied until a pulse duration is found that allows a steady state current condition to be reached. For example, the pulse duration may be adjusted by 0.5 to 2 times, ideally 0.8 to 1.5 times, from an un-adjusted value, where the un-adjusted duration is based on the rate of current decay in any preceding current-time period. The rate of decay may be determined by a measure of change in current magnitude over a period of time in which two or more, ideally at least ten, current measurements are recorded.

The degree of consumption and regeneration of a redox species may be regulated by determining a specific duration of pulsing based on the level of decay in current signal. This decay is an indicator of the degree of consumption or regeneration of the electrochemically active species. A feedback loop between application of potential and current would for example allow the degree of consumption and regeneration to be regulated.

Different regions of the sample may also be interrogated by controlling the frequency of polarity modulation applied to the electrode. Short pulses allow repeated recycling and measurement of the electrochemically active species close the electrode. Short pulses allow the implementation of relatively high frequency polarity modulation. During these short pulses the recently generated species diffuse a short distance in to the bulk solution prior to being re-measured at the same electrode through the application of an appropriate electrode potential. As a result solution viscosity can be measured close to the electrode surface. On the contrary, pulses having a relatively long duration, allow the species of interest to diffuse further into the bulk solution prior to the application of an appropriate over-potential. In this case, the frequency of polarity modulation is reduced. In addition the concurrent application of different frequency polarity modulations on separate measuring electrodes would allow different regions of the test sample to be interrogated simultaneously.

For all of the pulses mentioned above, the diffusion-related factor may be determined using current measured within the first 0.3 seconds of the under-potential and over-potential pulses. Preferably, the diffusion-related factor is measured using current measured after the first 0.2 seconds. By using current measured in the first 0.3 seconds, the diffusion-related factor determined is for the near electrode analyte. Equally, the diffusion-related factor may be determined using current measured after the first 0.3 seconds of the under-potential and over-potential pulses. By using current measured after the first 0.3 seconds, the diffusion-related factor determined is for the bulk analyte. The diffusion-related factor determined using current measured in the first 0.3 seconds and the diffusion-related factor determined using current measured after the first 0.3 seconds may be compared to provide information on mass transport in an analyte near a working electrode relative to mass transport in the same analyte further from the same electrode, as the diffusion boundary layer extends further from the electrode with time.

The methods described above can be used to determine the viscosity of a sample and the difference in viscosity between different solutions. Where multiple test solutions have different viscosities, the size and rate of current decay for each solution is different thus allowing the solution viscosity to be determined. Where appropriate or necessary this derived viscosity value can be used to correct the simultaneous measurements of other analytes of interest such as blood glucose.(discussed below).

Applications

The methods can be used for measuring assay of complex fluids such as biological fluids such as blood and in which the diffusion or viscosity changes over time. This change of viscosity may be due to temperature change, agglutination, gelling, coagulation, sedimentation, reaction, addition of other compounds, removal of compounds or any other physical change in the fluid.

By continuously switching the electrode potential from one that causes an oxidation of the species of interest to one that causes reduction of the species of interest, a real time measurement of solution viscosity is made possible without the need to employ moving components within the test strip and meter.

Different pulse sequences may be applied to the same electrode at different times, for example the pulse sequence of FIG. 14 could be applied and then the pulse sequence of FIG. 16. Equally, one potential pulse sequence may be applied, for example the pulse sequence shown in FIG. 15, at different times but with different pulse duration and magnitudes to the same electrode at different times. This allows the same electrode to interrogate separate regions of the test sample at different times. Such a configuration may allow substantial reductions in the required volume of the test sample.

VRF=k·T·DRF

where VRF is a Viscosity Related Factor of the sample, T is the temperature and k is a scaling constant.

The combined viscosity measurements of plasma and whole blood may reveal important information, allowing diagnosing the early signs of diseases. Change in the haemodynamics of blood has been shown to correlate with several disease states. Increase in viscosity correlates with thrombotic risk and may also be an indicator of early stage diabetes (type 2). The determination of the diffusion through plasma and diffusion through whole blood may be used to diagnose a state of health. Different pulsing frequencies can be utilized in a blood based assay to probe near electrode (plasma) diffusion and diffusion through the sample bulk (whole blood) which is defined by plasma diffusion and the tortuosity of path around cellular components. Current art teaches blood viscosity change due to change in haematocrit and plasma viscosity have opposite trends in the healthy individual in order to maintain whole blood viscosity. Utilizing the ratio of these viscosities may have diagnostic application in identifying risk and diagnosing early stages of a disease state. The whole blood plasma viscosity ratio can be calculated as:

$${W}_{BPVR} = \frac{{VRF}_{WB}}{{VRF}_{P}}$$

where VRF_{WB} is a viscosity related factor for whole blood, and VRF_{P} is the viscosity related factor for plasma.

The viscosity measurement of the method could also be used to measure erythrocyte sedimentation rate (ESR). The erythrocyte sedimentation rate, also called sedimentation rate, is the rate at which red blood cells sediment in a period of 1 hour. It is a common haematology test that is a non-specific measure of inflammation. To perform the test, anticoagulated blood is placed in an upright tube and the rate at which the red blood cells fall is measured and reported in mm/h. The pulsed potential method would facilitate greater resolution of changes in diffusion as sedimentation occurs that results could be delivered in significantly less than 1 hour.

The present method can also be used to determine a diffusion correction factor in a diagnostic assay. For example, the application of the present method in common blood based self-testing systems would be of advantage. Blood analyte testing systems are known to be sensitive to the haematocrit of the blood sample being measured. In many cases variations in sample haematocrit can lead to very substantial inaccuracies in analyte readings.

Given that patient haematocrits may range from 20% up to 60% it can be seen that some blood analyte monitoring systems may provide readings that differ by up to or more than 40% for different patients with the same blood analyte levels. The ability to simply and reliably measure parameters that strongly correlate to sample haematocrit on the same test strip as is used to measure other blood analyte may therefore allow the effects of haematocrit on the analyte measurement accuracy to be corrected for prior to returning a result. The concentration of analyte is calculated as:

[Analyte]=(k·DRF)·U_{CC}

where k is a pre-defined scaling constant, DRF is a diffusion-related factor of the analyte and U_{CC} is an Un-Corrected Calibration factor (calibrated value prior to correction for diffusion error).

Another example application of the present method relates to the measurement of blood clotting time. The measurement of blood clotting time is crucial to patients who are prescribed warfarin as an oral anticoagulant. An effective anticoagulant, warfarin (Coumadin) is harmful if taken in too high a dose. Consequently, Coumadin doses must be carefully titrated for each patient and this is made much easier with the use of self-testing blood clotting time devices. The present method enables the implementation of a simple blood clotting time test kit with both the test strip and the hand held meter being of low complexity.

Test Strip

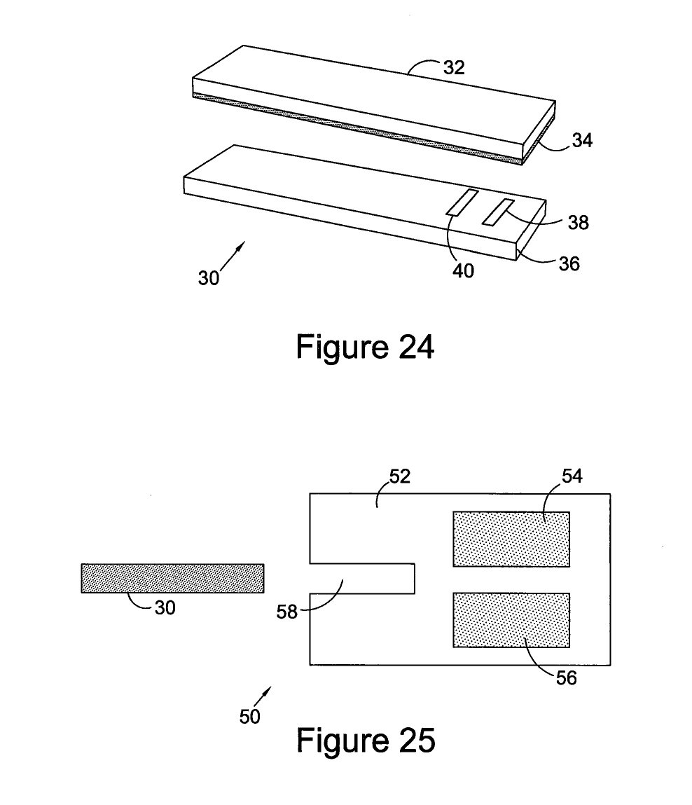

The present method can be performed using a test strip 30 as shown in FIG. 24 in combination with an electronic meter 50 as shown in FIG. 25. The test strip 30 has a support insulating layer 36, having at least one pair of electrodes 38 and 40: a working electrode and a counter/reference electrode. A reagent layer (not shown) covers all or part of the support insulating layer. A spacer 34 is sandwiched between the support layer 36 and a carrier substrate 32 (for transporting sample) and forming a sample chamber (not shown) extending around the electrode and where the sample can diffuse.

The electrodes should be made in a material that has a low electrical resistance, such as carbon, gold, platinum or palladium, allowing efficient electrochemistry to take place. The material of the working electrode may be different from the material of the counter/reference electrode. In this case the material of the working electrode should have an electrochemical activity that does not exceed the electrochemical activity of the material of the counter/reference electrode, ie. The counter/reference electrode should be non-limiting. For example, the working electrode could be made of carbon and a silver silver chloride reference/counter electrode.

The two electrodes may be of the same size or of different size. It may be of benefit to regulate by design the degree to which diffusion is defined by radial and planar diffusion. This could be achieved by designing electrodes with high surface to edge ratio to favour planar diffusion or vice versa to favour radial diffusion. Another option would be to recess the electrode or border it with walls to limit or prevent radial diffusion.

Working and counter/reference electrodes may be coated with the same reagents. These reagents should contain an electrochemically active species capable of undergoing reversible oxidation and reduction Example species include but are not limited to potassium hexacyanoferrate III, potassium hexacyanoferrate II, ferrocene and ferrocene derivatives, osmium based mediators, gentisic acid and their functionalized derivatives. The reagent layer may also contain ionic salts to support the electrochemistry within the chamber.

The test strip may comprise multiple measuring electrodes allowing different voltage modulation patterns to be applied simultaneously or allowing several diagnostic tests to be carried out simultaneously. For example, the strip may include one or more working electrodes, a counter electrode and a reference electrode. The counter and reference may be the same electrode.

The electrodes may optionally be enclosed within a sample chamber, such chamber having at least one aperture suitable for aspirating a sample of blood or other fluid of interest. The fill of the sample chamber may be aided by capillary, wicking, negative driven, electro-wetting or electro-osmotic forces. The reagents disposed on or around the electrodes may contain certain non-active film forming agents in addition to agents that promote the rapid dissolution of the electrochemically active species of interest in to the test sample.

The reagent layer(s) may over coat(s) one or more of the electrodes. In this case, substantially complete dissolution of the layer is required prior to interrogation of the bulk sample solution. Otherwise the layer itself would play a role in defining diffusion-related coefficients. The reagent layer may also be partially soluble over the measurement time. In this case, the rate of dissolution might provide a control measure.

The test strip is controlled using an electronic meter 50 having a test strip port 58 for the insertion of the test strip 30, a voltage control unit 54 configured to apply a voltage across the working and the counter electrodes present on the strip, means of measuring a current generated at the working electrode (not shown), a processor 56 for analysing the current generated at the working electrode, and a read out display.

Meter

The electronic meter determines that the sample is in position via detection of a physical parameter (such as a resistance, capacitance, current, etc. . . . ) reaching a threshold value upon insertion of the strip.

The meter has a voltage control unit 54 that is capable of applying and modulating the potential difference between two electrodes such that the species of interest can be repeatedly oxidised and reduced at the same electrode surface. The pulsed potential waveform may be defined as described above and predetermined by the meter. When the test strip is equipped with multiple electrodes pairs, the control unit can be configured to control each pair separately. In this case each pair may be modulated with a different pulse rate and/or different voltage amplitude. The means for measuring the current is configured to sample current at a frequency equal or greater than 0.2 Hz. The current can be measured at a defined time point or at a peak value. The processor can determine the current rate of change. The meter is adapted to perform the methods described above. This can be done under the control of software and/or hardware.

A skilled person will appreciate that variations of the disclosed arrangements are possible without departing from the invention. Accordingly the above description of the specific embodiment is made by way of example only and not for the purposes of limitation. It will be clear to the skilled person that minor modifications may be made without significant changes to the operation described.

1-47. (canceled)

48. A method of measuring a sample that includes at least one reactant that can be oxidised and reduced between at least one working electrode and a counter electrode, the method comprising the steps of:
applying across the working and counter electrodes a cycle of at least three pulses; and
measuring current at the working electrode during each pulse,
wherein the at least three pulses comprise:
at least one over-potential pulse that has an amplitude equal to or greater than an oxidation or a reduction peak potential of the reactant;
at least one under-potential pulse of amplitude less than the at least one over-potential pulse; and
at least one other over-potential pulse or under-potential pulse.

49. A method according to claim 48, wherein the cycle includes at least one oxidation over-potential and at least one reduction over-potential.

50. A method according to claim 48, wherein the cycle includes at least one reduction over-potential and at least one reduction under-potential.

51. A method according to claim 48, wherein the cycle includes at least one oxidation over-potential and at least one oxidation under-potential.

52. A method according to claim 48, wherein the cycle includes at least one reduction over-potential, at least one reduction under-potential and at least one oxidation over-potential.

53. A method according to claim 48, wherein each pulse in the cycle has a different amplitude.

54. A method according to claim 48, further comprising applying multiple cycles.

55. A method according to claim 48, where a cycle comprises in sequence an under-potential, an over-potential, and an over-potential.

56. A method according to claim 48, wherein the cycle comprises in sequence an under-potential, an under-potential, and an over-potential.

57. A method according to claim 48, wherein the cycle comprises in sequence an under-potential, an over-potential, and an under-potential.

58. A method according to claim 48, wherein the cycle has at least four pulses.

59. A method according to claim 58, wherein the cycle comprises in sequence an under-potential, an over-potential, an under-potential and an over-potential.

60. A method according to claim 58 wherein the cycle comprises in sequence an under-potential, an under-potential, an over-potential and an over-potential.

61. A method according to claim 48, wherein at least one pulse is of a different polarity to other pulses in the cycle.

62. A method according to claim 48, wherein applying an under-potential is done immediately before applying an over-potential.

63. A method according to claim 48, wherein each potential is applied for a duration of between 0.02 s and 10 s.

64. A method according to claim 48, wherein the last over-potential time duration is longer than the other pulses.

65. A method according to claim 48, wherein at least one of the under-potential pulse duration or the over-potential pulse duration is determined according to a level of decay rate in at least one of the under-potential current or the over-potential current.

66. A method according to claim 48, wherein the under-potential pulse duration is different to the over-potential pulse duration.

67. A method according to claim 48, wherein the under-potential pulse duration is the same as the over-potential pulse duration.

68. A method according to claim 48, further comprising using measured under-potential and over-potential currents to determine a diffusion-related factor.

69. A method according to claim 68, further comprising calculating a ratio of the under-potential current and the over-potential current; and using the ratio to determine the diffusion-related factor.

70. A method according to claim 68, further comprising using a current value and the ratio to derive a diffusion-related factor.

71. A method according to claim 69, further comprising using additional current values with the ratio to derive a diffusion-related factor.

72. A method as claimed in claim 68, further comprising determining the diffusion-related factor using the rate of change in the measured under-potential and/or over-potential current.

73. A method as claimed in claim 68, further comprising determining the diffusion-related factor using a ratio of the rate of change in at least one of the measured under-potential or the measured over-potential current.

74. A method as claimed in claim 68, further comprising using the diffusion-related factor and a temperature dependent coefficient to obtain a viscosity related factor of the sample.

75. A method as claimed in claim 68, further comprising using the diffusion-related factor to determine a change in viscosity or diffusion.

76. A method as claimed in claim 68, further comprising using the diffusion-related factor to determine relative diffusion in a plasma versus whole blood.

77. A method as claimed in claim 68, further comprising using the diffusion-related factor as at least one of a diagnostic value or an indicator of health.

78. A method as claimed in claim 68, further comprising using the diffusion-related factor to determine an analyte concentration in the sample.

79. A method as claimed in claim 68, further comprising using the diffusion-related factor and a correction factor in obtaining the concentration of an analyte in the sample.

80. A method as claimed in claim 68, further comprising determining the diffusion-related factor using current measured within the first 0.3 seconds of the under-potential and over-potential pulses.

81. A method as claimed in claim 68, further comprising determining the diffusion-related factor using current measured after the first 0.3 seconds of the under-potential and over-potential pulses.

82. A method as claimed in claim 81, further comprising:
determining the diffusion-related factor using current measured within the first 0.3 seconds of the under-potential and over-potential pulses; and
comparing the diffusion-related factor determined using current measured in the first 0.3 seconds and the diffusion-related factor determined using current measured after the first 0.3 seconds.

83. A method according to claim 48, wherein the analyte of interest in the sample is at least one metabolic marker.

84. A method according to claim 83, wherein the at least one metabolic marker is at least one of glucose or cholesterol.

85. A method according to claim 48, wherein the working electrode and the counter electrode are swapped during measurement.

86. A method according to claim 48, wherein the potential pulses have at least one of a square wave profile, a sinusoidal wave profile, a triangular wave profile, or a ramp profile.

87. A method according to claim 48, comprising using a reference electrode.

88. A method according to claim 87, wherein the counter and reference electrodes are separate electrodes.

89. A method according to claim 87, wherein the counter and reference electrodes are combined in a single electrode.

90. A method according to claim 48, wherein the under-potential pulse duration is two or more times longer than any over-potential pulse.

91. A method according to claim 48, wherein between pulses there is a transition period, the transition being between 0 and 5 seconds.

92. A method according to claim 48, wherein between pulses there is a transition period, the transition being between 0 and 0.1 seconds.

93. A method according to claim 48, comprising using a plurality of working electrodes.

94. A method according to claim 48, comprising integrating the current measured over a time period starting 0.01 to 0.1 seconds after the start of a pulse and lasting 0.15 to 3 seconds to give an integrated current.

95. A method according to claim 48, comprising integrating the current measured over a time period starting 0.01 to 0.1 seconds after the start of a pulse and lasting 0.2 to 0.5 seconds to give an integrated current.

96. A method according to claim 94 comprising using integrated current of two or more pulses to derive an analyte parameter.

97. A method according to claim 94 comprising using integrated current for two pulses to derive a diffusion-related factor.

98. A meter having a voltage source and a current meter adapted to perform the method of claim 48.
